(19) United States
(12) Patent Application Publication
(10) Pub. No.: US 2025/0277906 A1
(43) Pub. Date: Sep. 4, 2025

(54) SIGNAL PROCESSING APPARATUS AND METHOD FOR LIGHT-RECEIVING ELEMENT

(71) Applicants: SOLIDVUE, INC., Gyeonggi-do (KR); RESEARCH & BUSINESS FOUNDATION SUNGKYUNKWAN UNIVERSITY, Gyeonggi-do (KR)

(72) Inventors: Hyeong Seok SEO, Gyeonggi-do (KR); Can Xing PIAO, Gyeonggi-do (KR); Won Jong ROH, Gyeonggi-do (KR); Jae Hyuk CHOI, Seoul (KR)

(73) Assignees: SOLIDVUE, INC., Gyeonggi-do (KR); RESEARCH & BUSINESS FOUNDATION SUNGKYUNKWAN UNIVERSITY, Gyeonggi-do (KR)

(21) Appl. No.: 18/920,180

(22) Filed: Oct. 18, 2024

(30) Foreign Application Priority Data
Feb. 29, 2024 (KR) 10-2024-0030006
Jun. 12, 2024 (KR) 10-2024-0076609

(51) Int. Cl. G01S 17/89; G01S 7/481; G01S 7/4861; G01S 7/487

(52) U.S. Cl. CPC G01S 17/89; G01S 7/4816; G01S 7/4861; G01S 7/4876

(57) ABSTRACT

Provided is a signal processing apparatus and method for a light-receiving element. The signal processing apparatus includes a signal detection unit configured to perform photonic event detection processes in parallel for at least two light-receiving elements of a pixel array and a histogram generation unit configured to accumulate detection results about photonic events recognized at predefined time intervals by the signal detection unit in a plurality of bins and generate a histogram.

### CROSS-REFERENCE TO RELATED APPLICATION

This application is based on and claims priority under 35 U.S.C. § 119 to Korean Patent Application No. 10-2024-0030006, filed on Feb. 29, 2024, and Korean Patent Application No. 10-2024-0076609, filed on Jun. 12, 2024, in the Korean Intellectual Property Office, the disclosures of which are incorporated by reference herein in its entirety.

### BACKGROUND

### 1. Field

The disclosure relates to a method and apparatus for processing a signal of a light-receiving element, and more particularly, to a method and apparatus for processing a signal of a time-to-digital converter (TDC) of a light-receiving element, which is used by a light detection and ranging (LiDAR) sensor, an image sensor, or the like, to measure a time of flight (ToF).

### 2. Description of the Related Art

FIG. 1 shows an example of a conventional light detection and ranging (LIDAR) sensor. A LIDAR sensor 100 outputs a laser signal in a pulse form by using a light-emitting element 110 such as a vertical cavity surface emitting laser (VCSEL)/edge emitting laser diode (EELD), etc. A light-receiving element 120 monitors the laser returned after being reflected from an object 130. An example of the light-receiving element 120 may include a single photon avalanche diode (SPAD). The LiDAR sensor 100 may recognize a distance to the object 130 by measuring a time (i.e., a time of flight (ToF)) during which the laser output from the light-emitting element 100 is returned after being reflected from the object 130. To improve an angular resolution of the LiDAR sensor 100, a resolution of a pixel for detecting light in the light-receiving element 120 needs to be improved.

FIG. 2 shows an example of an arrangement structure of a light-receiving element and a time-to-digital converter (TDC) of a LIDAR sensor. Referring to FIG. 2, an hTDC element 210 is arranged in each column of a pixel array 200. To improve the resolution of a pixel, the number of hTDCs 210 needs to be increased, and in this case, the total area of the hTDCs 210 also increases, which increases the size of the light-receiving sensor.

FIG. 3 shows an example of an object recognition result with respect to a distance of a LiDAR sensor. Referring to FIG. 3, even when a field of view (FoV) is increased using a lens of the LiDAR sensor, an angular resolution may not be improved. As a low-resolution pixel array may not obtain a high-resolution image of a distant object, objects 302 and 312, which are recognized in a short range 300 and a mid-range 310, respectively, may not be recognized in a long range 320. To recognize an object 322 in the long range 320, the resolution of the LiDAR sensor has to be improved. To improve the resolution, the number of hTDCs has to be increased as shown in FIG. 2, and in this case, the area of the LiDAR sensor also increases.

### SUMMARY

Provided is a signal processing method and apparatus capable of implementing a light-receiving sensor with multiple resolutions while maintaining an area of a time-to-digital converter (TDC).

Additional aspects will be set forth in part in the description which follows and, in part, will be apparent from the description, or may be learned by practice of the presented embodiments of the disclosure.

According to an aspect, a signal processing apparatus includes a signal detection unit configured to perform photonic event detection processes in parallel for at least two light-receiving elements of a pixel array and a histogram generation unit configured to accumulate detection results about photonic events recognized at predefined time intervals by the signal detection unit in a plurality of bins and generate a histogram.

According to another aspect, a signal processing method performed by a signal processing apparatus connected to a pixel array includes performing photonic event detection processes in parallel for at least two light-receiving elements of a pixel array and accumulating detection results about photonic events recognized at predefined time intervals by the signal detection unit in a plurality of bins and generating a histogram.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows an example of a conventional light detection and ranging (LiDAR) sensor;

FIG. 2 shows an example of an arrangement structure of a light-receiving element and a time-to-digital converter (TDC) of a LIDAR sensor;

FIG. 3 shows an example of an object recognition result with respect to a distance measured using a LiDAR sensor;

FIG. 4 shows an example of a light-receiving sensor in which a signal processing apparatus according to an embodiment is implemented;

FIG. 5 shows an example of a pixel structure of a pixel array according to an embodiment;

FIG. 6 shows an example of a mode conversion method of a signal processing apparatus according to an embodiment;

FIG. 7 shows a configuration of an example of a signal detection unit in a macro mode, according to an embodiment;

FIG. 8 shows an example of a timing diagram of the signal detection unit of FIG. 7;

FIG. 9 illustrates a configuration of an example of a signal detection unit in a QR mode, according to an embodiment;

FIG. 10 shows an example of a timing diagram of the signal detection unit of FIG. 9;

FIGS. 11 to 13 show a configuration of an example of a histogram generation unit according to an embodiment;

FIG. 14 shows an example of a histogram memory according to an embodiment;

FIG. 15 shows an example of histograms in a macro mode and in a QR mode, according to an embodiment;

FIGS. 16 and 17 show an example of a method of improving a time resolution of a histogram, according to an embodiment; and

FIG. 18 shows an example of a signal processing method for implementing multi-resolutions, according to an embodiment.

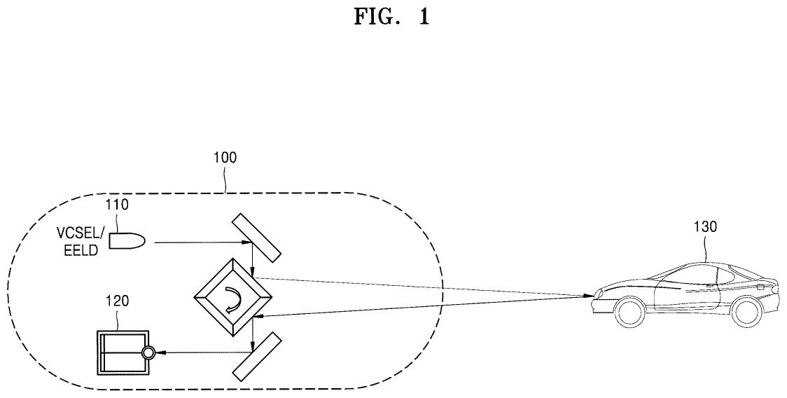

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a signal processing method and apparatus for a light-receiving element according to an embodiment will be described in detail with reference to the accompanying drawings.

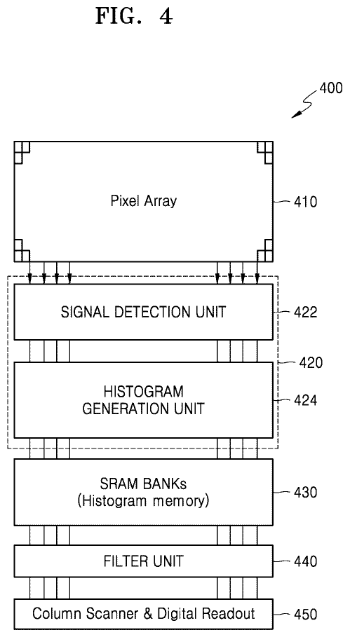

FIG. 4 shows an example of a light-receiving sensor in which a signal processing apparatus according to an embodiment is implemented.

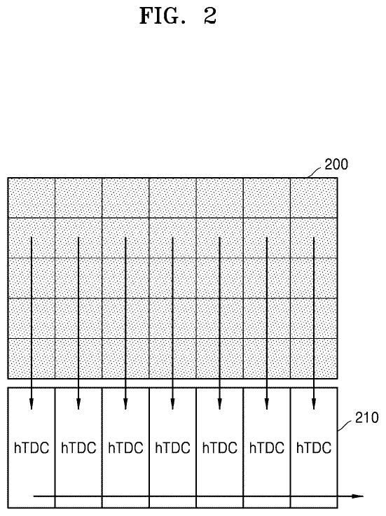

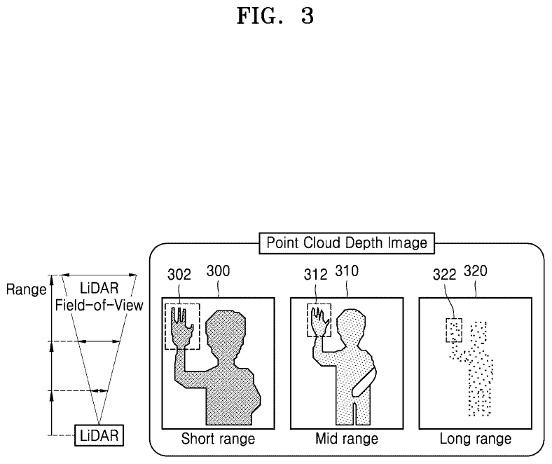

Referring to FIG. 4, a signal processing apparatus 420 may include at least one signal detection unit 422 and at least one histogram generation unit 424. In another embodiment, the signal processing apparatus 420 may further include at least one filter unit 440. The TDC of the light-receiving sensor of FIG. 2 may be implemented with the signal processing apparatus 420 according to the current embodiment. For example, the hTDC 210 of FIG. 2 may be implemented with the signal detection unit 422 and the histogram generation unit 424. The signal processing apparatus 420 according to the current embodiment may be applied to various fields, and such application fields are not limited to the light-receiving sensor 400 according to the current embodiment. However, for convenience of a description, it will be assumed in the description that the signal processing apparatus 420 is used as a TDC of the LiDAR light-receiving sensor 400.

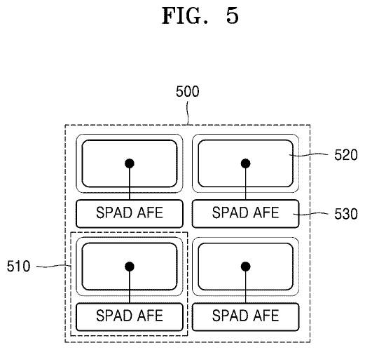

A pixel array 410 may include a plurality of light-receiving elements. For example, the pixel array 410 may include a plurality of light-receiving elements in an array of n*m (n and m are natural numbers of at least 2). The light-receiving element may be an element for detecting light, and may be, for example, an SPAD, etc. One light-receiving element may constitute one pixel, or a plurality of light-receiving elements may constitute one pixel. Hereinbelow, the pixel including the plurality of light-receiving elements will be referred to as a macro-pixel. An example of the macro-pixel is shown in FIG. 5.

The signal detection unit 422 and the histogram generation unit 424 of the signal processing apparatus 420 may be disposed in each column of a macro-pixel array of the pixel array 410. For example, when the pixel array 410 includes 200 (Horizontal)*50 (Vertical) macro-pixels, the signal processing apparatus (420) may include 200 signal detection units 422 and 200 histogram generation units 424 respectively corresponding to 200 macro-pixels in the horizontal direction. The signal detection unit 422 and the histogram generation unit 424 located in each column may correspond to the hTDC 210 of FIG. 2. That is, the signal processing apparatus 420 may include 200 hTDCs.

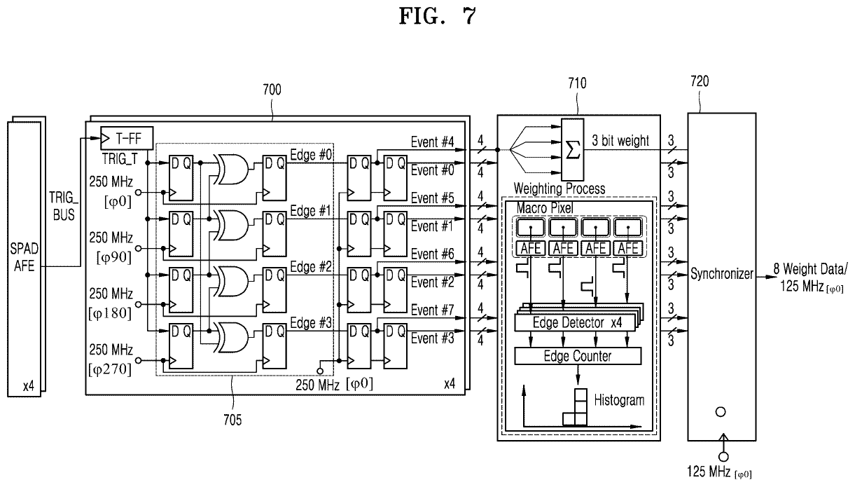

As a configuration and operating process of the signal detection unit 422 and the histogram generation unit 424 in each column are the same, the following description will be made based on the signal processing apparatus 420 (i.e., one hTDC) including one signal detection unit 422 and one histogram generation unit 424 corresponding to one macro-pixel for convenience of the description. The signal processing apparatus 420 may generate a histogram for each pixel to recognize a ToF. A detailed configuration of the signal processing apparatus 420 will later be described again with reference to FIG. 7.

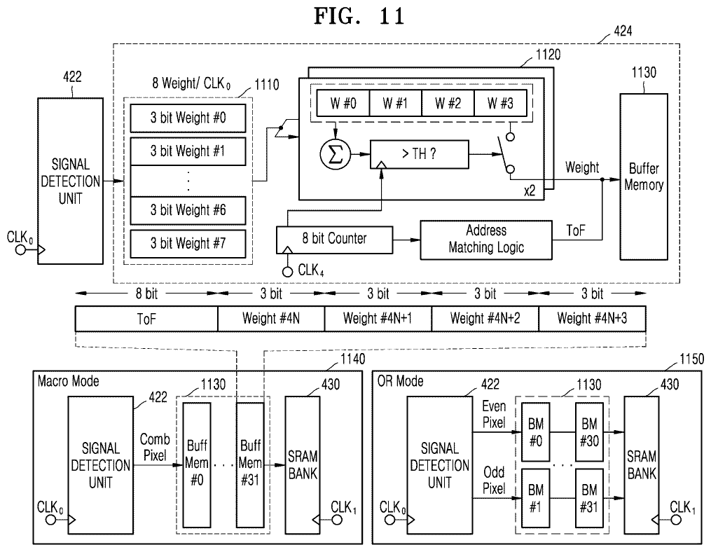

The memory 430 may store a histogram for each pixel for ToF measurement. The memory 430 may be a static random-access memory (SRAM). In addition, various types of storage elements may be used as the memory 430 according to the current embodiment, and the memory 430 is not limited to the SRAM. Hereinbelow, a region of the memory 430 storing a histogram will be referred to as a ‘histogram memory’. A detailed method for generating a histogram will be described again with reference to FIGS. 11 to 14.

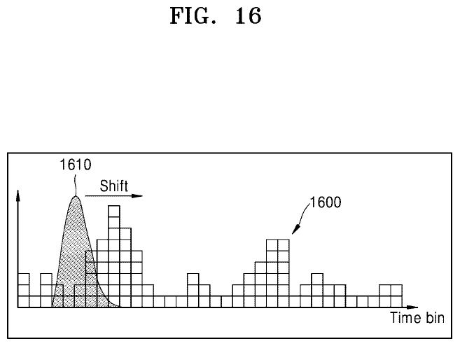

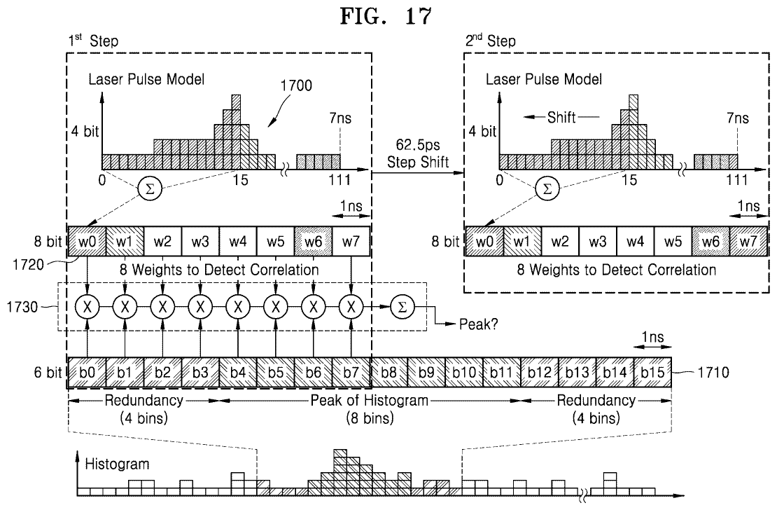

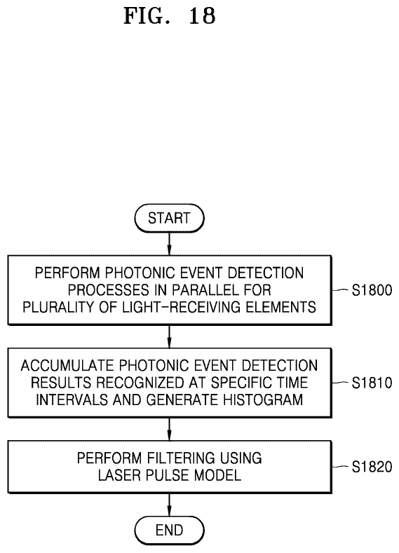

The filter unit 440 may improve a time resolution through a laser pulse model that simulates a shape of a laser pulse used for ToF measurement and a convolution process of a histogram stored in the histogram memory. That is, the filter unit 440 may operate as a sort of depth refining filter. A detailed configuration of the filter unit 440 will be described in detail with reference to FIGS. 16 and 17. The filter unit 440 may be omitted depending on an embodiment. An output unit 450 may output ToF data refined by the filter unit 440. When the filter unit 440 is omitted, the output unit 450 may output the histogram stored in the memory 430.

FIG. 5 shows an example of a pixel structure of a pixel array according to an embodiment.

Referring to FIG. 5, a macro-pixel 500 may include a plurality of light-receiving elements. Each light-receiving element 520 may be connected to an analog front end (AFE) 530. While it is illustrated in the current embodiment that the light-receiving element 520 and the AFE 530 are one-to-one mapped to facilitate understanding, this is merely an example such that an array structure of light-receiving elements and AFEs in a pixel array may be various and is not limited to the current embodiment. The AFE 530 is widely known and thus will not be described.

In an embodiment, the macro-pixel 500 may include an 2*2 array of light-receiving elements. The macro-pixel 500 may also be implemented as various light-receiving element array structures such as n*1 or 1*n (n is a natural number of at least 2), n*m (n and m are natural numbers of at least 2), etc. However, hereinbelow, for convenience of a description, the description will be made assuming that the macro-pixel 500 includes light-receiving elements of a 2*2 array. The signal processing apparatus 420 may measure a ToF for each macro-pixel 500 and generate a histogram.

In another embodiment, the signal processing apparatus 420 may divide the macro-pixel 500 into a plurality of sub-pixels, measure a ToF for each sub-pixel, and generate a histogram. For example, a sub-pixel 510 including one light-receiving element may be defined by quartering the macro-pixel 500 of the 2*2 array. Although it is illustrated in the current embodiment that the sub-pixel 510 includes one light-receiving element, this is merely an example and the number of light-receiving elements constituting the sub-pixel 510 may be changed variously according to a method of dividing the macro-pixel 500. However, hereinbelow, for convenience of a description, the description will be made assuming that the sub-pixel 510 includes one light-receiving element.

A pixel used by the signal processing apparatus 420 for ToF measurement may be a macro-pixel or a sub-pixel. For example, when the pixel array 410 includes 200*50 macro-pixels and ToF measurement is performed for each macro-pixel, then a resolution may be 200*50. When a pixel array of 200*50 macro-pixels are divided into sub-pixels and ToF measurement is performed for each sub-pixel, then a resolution may be 400(=200*2)*100(50*2). In other words, by dividing the macro-pixel 500 into the sub-pixels 510 in the pixel array 410, a resolution may be improved.

In the current embodiment, by using the signal detection unit 422 and the histogram generation unit 422 of the signal processing apparatus 400, used for signal processing of a macro-pixel, signal processing of a sub-pixel may be performed. Hereinbelow, a mode for a macro-pixel-based operation will be referred to as a macro mode, and a sub-pixel quartering a macro-pixel including 2*2 light-receiving elements will be referred to as a quadruple resolution (QR) pixel, and a mode for a QR pixel-based operation will be referred to as a QR mode.

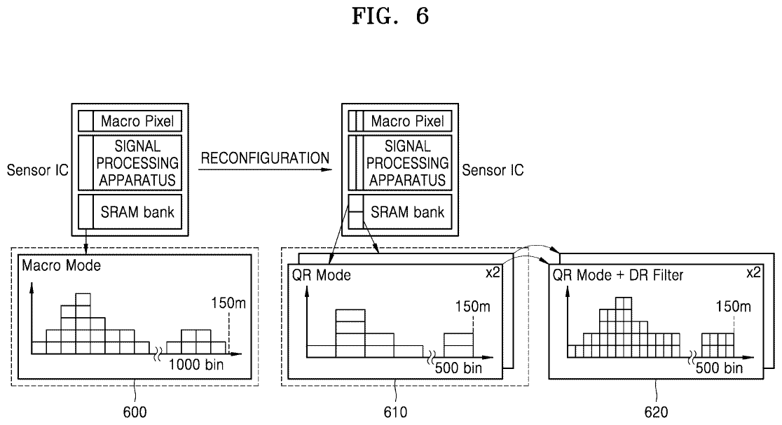

FIG. 6 shows an example of a mode conversion method of a signal processing apparatus according to an embodiment.

Referring to FIG. 6, the signal processing apparatus 420 may operate in the macro mode 600 or the QR mode 610 according to user's setting or a surrounding environment. In the macro mode 600, the signal processing apparatus 420 may process a photonic event detection process of a pixel array for each macro-pixel. The photonic event may occur when light is incident to a light-receiving element. In the QR mode 610, the signal processing apparatus 420 may process the photonic event detection process of the pixel array for each QR pixel.

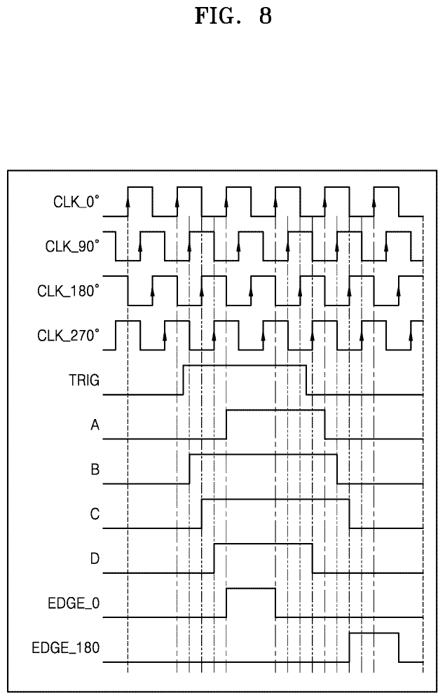

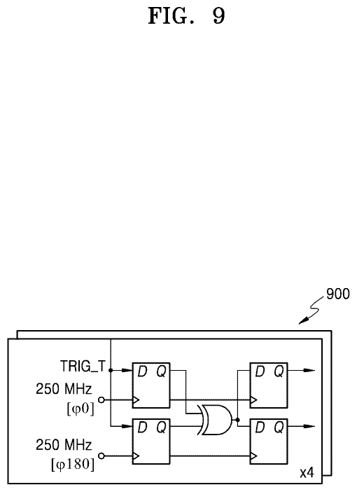

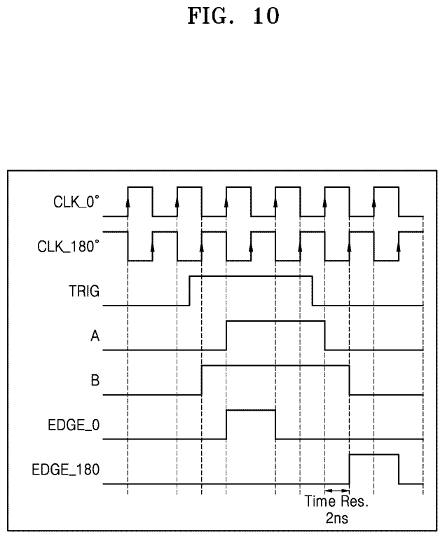

The signal processing apparatus 420 may generate a histogram including a plurality of bins for each macro-pixel or QR pixel according to the operation modes 600 and 610. The number of bins may be defined as a value obtained by dividing a maximum detection range of a light-receiving sensor by a predefined time interval. For example, when a maximum detection range of a LIDAR sensor is 150 m, a histogram including 1000 bins in the unit of 1 ns (corresponding to 15 cm) or a histogram including 500 bins in the unit of 2 ns may be generated. The maximum detection range, the number of bins included in a histogram, and a size of a time interval of each bin may be changed variously. An example of the signal detection unit 422 for photonic event detection in the macro mode 600 is shown in FIGS. 7 and 8, and an example of the signal detection unit 422 for photonic event detection in the QR mode 610 is shown in FIGS. 9 and 10. An example of the histogram generation unit 424 is shown in FIG. 11.

In an embodiment, the signal processing apparatus 420 may detect whether a photonic event of each light-receiving element occurs while scanning the pixel array 410 from left to right or from up to down. Assume that the pixel array includes 400*100 light-receiving elements. In this case, in an operation in a macro mode 600 using a macro-pixel of FIG. 5, the signal processing apparatus 420 may perform a photonic event detection process while simultaneously scanning two rows of the light-receiving element. In an operation in a QR mode 610, the signal processing apparatus 420 may perform the photonic event detection process while sequentially scanning one row of the light-receiving element. That is, in the macro mode 600, row scanning is performed 50 times, whereas in the QR mode 610, row scanning may be performed 100 times.

The signal detection unit 422 and the histogram generation unit 424 may exist for each column of a macro-pixel, such that in the QR mode 610, the photonic event detection process of two QR pixels in the horizontal direction may be performed in parallel. That is, in the QR mode 610, one hTDC processes a photonic event occurring in two pixels (i.e., two QR pixels) in parallel, thus showing an effect as if the number of channels increases twice.

In the macro mode 600, the signal processing apparatus 420 detects photonic events of a plurality of light-receiving elements included in a macro-pixel and generate one histogram, but in the QR mode 610, the signal processing apparatus 420 may separately detect photonic events of two QR pixels and generates two histograms in parallel. When a size of a histogram memory is fixed, to store two histograms, in the QR mode 610, the number of bins of each histogram may be reduced to a half of the number of bins in the macro mode 600. For example, when a histogram for the macro mode 600 includes 1000 bins, a histogram of the QR mode 610 may include 500 bins.

In another embodiment, the signal processing apparatus 420 may generate ToF data 620 in which a time resolution of a histogram obtained in the QR mode 610 is improved through the filter unit 440, and a detailed method for obtaining ToF data will be described again with reference to FIGS. 16 and 17.

FIG. 7 shows a configuration of an example of a signal detection unit in a macro mode, according to an embodiment. FIG. 8 shows an example of a timing diagram of the signal detection unit of FIG. 7.

Referring to FIG. 7, the signal detection unit 422 may include a plurality of edge detectors 700 and a weight recognition unit 710. The plurality of edge detectors 700 may be one-to-one mapped to the plurality of light-receiving elements to perform photonic event detection processes for the respective light-receiving elements in parallel.

In an embodiment, for the macro pixel 500 of FIG. 5, the signal detection unit 422 may include four edge detectors 700 that perform photonic event detection in parallel for four light-receiving elements constituting the macro pixel 500. The number of edge detectors 700 may be determined according to the number of light-receiving elements constituting the macro-pixel 500. Configurations and operation processes of the plurality of edge detectors 700 are the same, and thus a description will be made based on one edge detector 700 in the current embodiment.

The edge detector 700 may receive a trigger signal TRIG_BUS indicating occurrence of photonic event from the AFE 530 of each light-receiving element of the macro-pixel 500 of FIG. 5. The edge detector 700 may detect a trigger signal. For example, to implement a detection range of 150 m, the edge detector 700 may detect 1000 times whether a trigger signal exists in the unit 1 ns (corresponding to a detection distance of 15 m). The histogram generation unit 424 may accumulatively record the number of photonic event detections in a histogram including 1000 bins having a size of 1 ns. A size of a time interval (i.e., a time interval of a bin) for detecting a trigger signal by the edge detector 700 and the number of time intervals (i.e., the number of bins) may be changed variously according to an embodiment. For example, when a time interval of a bin of a histogram in a macro mode is 1 ns, the edge detector 700 may detect whether a trigger signal is generated at intervals of 1 ns.

In an embodiment, the edge detector 700 may be implemented with a plurality of flipflops. A T-flipflop of the edge detector 700 may convert the trigger signal TRIG_BUS generated in a light-receiving element into an edge signal. The edge detector 700 may be implemented using a plurality of edge-detection flipflops 705 that operate in different phases at a common clock frequency (e.g., 250 MHZ). For example, the signal detection unit 422 having a time resolution of 1 ns may be implemented with the edge detector 700 operating at a clock of 4-phase 250 MHz. That is, occurrence of a photonic event may be detected at intervals of 1 ns by using four flipflops 705 having a phase difference of 90 degrees. An example of such a timing diagram is shown in FIG. 8. An edge detection method using flipflops is well known and thus will not be described in detail. In another embodiment, the edge detector 700 may be implemented to detect a trigger signal at intervals of 1 ns by using one flipflop operating at a clock frequency of 1 GHz rather than flipflops operating in different phases.

In another embodiment, considering a width (e.g., 8 ns) of a laser pulse used for ToF measurement, the edge detector 700 may output, in parallel, results of measurement during a measurement period (e.g., 8 ns) corresponding to the width of the laser pulse. When the width of the laser pulse is changed, the measurement period of the edge detector 700 may also be changed.

The weight recognition unit 710 may output a weight obtained by summing photonic event detection results of a plurality of light-receiving elements constituting a macro-pixel. In the current embodiment, each of the four edge detectors 700 may detect, at intervals of 1 ns, whether a photonic event occurs. The weight recognition unit 710 may recognize, at intervals of 1 ns, the number of light-receiving elements where a photonic event occurs among the four light-receiving elements of the macro-pixel. That is, the weight recognition unit 710 may count the number of photonic events occurring during 1 ns in the macro-pixel to recognize the weight.

For example, when a photonic event occurs in one light-receiving element of the macro-pixel at a point of 1 ns and photonic events occur in three light-receiving elements of the macro-pixel at a point of 2 ns, the weight recognition unit 710 may determine a weight at a point of 1 ns as 1 and a weight at a point of 2 ns as 3.

When the four edge detectors 700 output results of measurement during 8 ns in parallel, photonic event detection results with respect to eight time intervals (i.e., eight at intervals of 1 ns) may be output in parallel from four edge detectors 700 and thus the weight recognition unit 710 may include eight edge counters for parallel processing. For example, a first edge counter may output a weight obtained by summing photonic event detection results of the four edge detectors 700 for a point of 1 ns, and a second edge counter may output a weight obtained by summing photonic event detection results of the four edge detectors 700 for a point of 2 ns.

The number of edge counters constituting the weight recognition unit 710 may be determined according to the number of time intervals for parallel output of the edge detectors 700. The weight recognition unit 710 may transmit eight weights recognized through eight edge counters to the histogram generation unit 424. In an embodiment, a synchronizer 720 may be further included to synchronize output values of the eight edge counters and transmit the same to the histogram generation unit 424.

FIG. 9 illustrates a configuration of an example of a signal detection unit in a QR mode, according to an embodiment. FIG. 10 shows an example of a timing diagram of the signal detection unit of FIG. 9.

Referring to FIG. 9, the signal detection unit 422 may include a plurality of edge detectors 900. The signal detection unit 422 may perform photonic event detection processes in parallel for four light-receiving elements constituting a macro-pixel in a macro mode. In a QR mode, the signal detection unit 422 may process photonic event detection processes of two QR pixels in parallel. The signal detection unit 422 may reconfigure the signal detection unit 422 in the macro mode and use the same in the QR mode.

When the edge detector 700 for the macro mode is as shown in FIG. 7, an edge detector 900 for the QR mode may detect whether a photonic event occurs at intervals of 2 ns by using two flipflops operating in phases having a difference of 180 degrees at a common clock frequency of 250 MHz. That is, an edge detector 705 of a resolution of 1 ns operating at a 4-phase clock in the macro mode may be reconfigured by the edge detector 900 of a resolution of 2 ns operating at a 2-phase clock and used in the QR mode.

The signal detection unit 422 may output, in parallel, four detection results for detecting photonic events at intervals of 2 ns for a QR pixel (hereinafter, an ‘odd pixel’) located to the left and four detection results for detecting photonic events at intervals of 2 ns for a QR pixel (hereinafter, an ‘even pixel’) located to the right, between two QR pixels arranged in the horizontal direction in the macro-pixel. That is, in the QR mode, the signal detection unit 422 may detect, in parallel, photonic events occurring in two pixels (the odd pixel and the even pixel) and classify them according to time. Herein, 2 ns may be the same as a time interval of a bin of a histogram for ToF measurement of a QR pixel.

In the QR mode, a pixel-based weight does not need to be calculated, such that the weight recognition unit 710 of FIG. 7 may output a value input from the edge detector 900 in the QR mode. Thus, without adding separate hardware for a QR mode operation, a configuration of the signal detection unit 422 used in the macro mode may be reconfigured to operate in the QR mode.

In the QR mode, a photonic event detection result of a QR pixel of the signal detection unit 422 may be output through the weight recognition unit 710, such that a value output by the signal detection unit 422 in the QR mode will be referred to as a weight. While a weight may be from 0 to 4 according to the number of light-receiving elements where a photonic event occurs in a macro pixel in the macro mode, the weight may be 0 or 1 in the QR mode.

FIG. 11 shows a configuration of an example of a histogram generation unit according to an embodiment.

Referring to FIG. 11, the histogram generation unit 424 may accumulate photonic event detection results detected by the signal detection unit 422 in a plurality of bins and generate a histogram. In the current embodiment, it is shown that eight detection results are received from the signal detection unit 422. For example, the signal detection unit 422 may output a weight recognized at in intervals of 1 ns during 8 ns in the macro mode, and output a weight recognized at intervals of 2 ns for each of the odd pixel and the even pixel during 8 ns in the QR mode. The number of weights output from the signal detection unit 422 may be the same in the macro mode and the QR mode. Thus, the histogram generation unit 424 may be used in common in the macro mode and the QR mode.

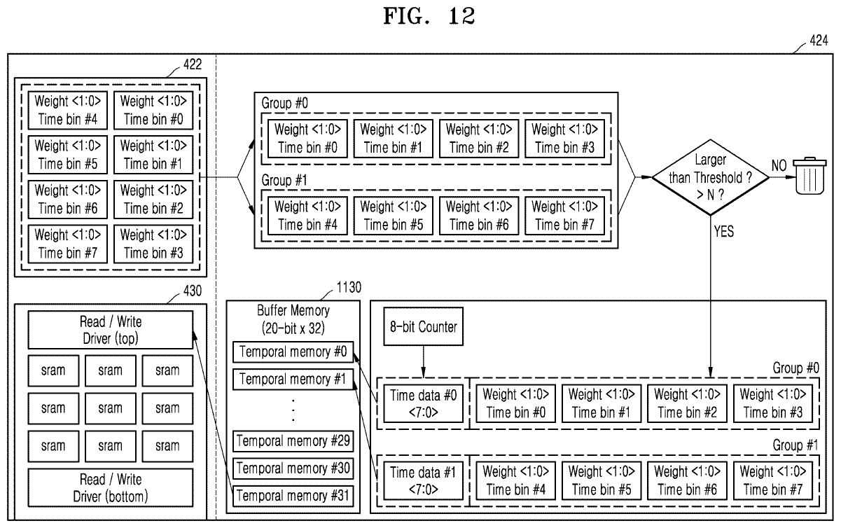

An operation process of the histogram generation unit 424 in a macro mode 1140 will be described with reference to FIGS. 11 and 12 together.

Upon input of eight weights 1110 detected at intervals of 1 ns for a macro-pixel, the histogram generation unit 424 may classify them into a first group including four upper weights (i.e., weights #0, 1, 2, 3) and a second group including four lower weights (i.e., weights #4, 5, 6, 7) and recognize whether a sum of weights in each group (i.e., a sum of the first group=weight #0+weight #1+weight #2+weight #3, a sum of the second group=weight #4+weight #5+weight #6+weight #7) exceeds a predefined threshold value, in operation 1120. When a sum of weights in each group is less than or equal to the threshold value, the histogram generation unit 424 may discard all the weights of the group and do not reflect them in the histogram. In an embodiment, the histogram generation unit 424 may recognize, in parallel, whether the sum of weights in each group exceeds the threshold value.

When a sum of weights in a group exceeds the threshold value, the histogram generation unit 424 may store the weights of the group in a buffer memory 1130. The histogram generation unit 424 may match the weights to a ToF value indicating a point in time of detection of a photonic event and store the weights of the group in the buffer memory 1130. The ToF value may be mapped to a memory address.

In an embodiment, the buffer memory 1130 may be implemented in a first input first output (FIFO) form. The histogram generation unit 424 may accumulatively store the weights stored in the buffer memory 1130 in a histogram of the histogram memory. The histogram generation unit 424 may accumulate the weights at a memory address corresponding to the ToF value stored in the buffer memory 1130. That is, detection time information of a photonic event may indicate a bin position (i.e., a bin number) and may be used as memory address information.

While an example of the buffer memory 1130 including 32 buffers is shown in the current embodiment, this is merely an example and the number of buffers constituting the buffer memory 1130 may be changed variously depending on an embodiment.

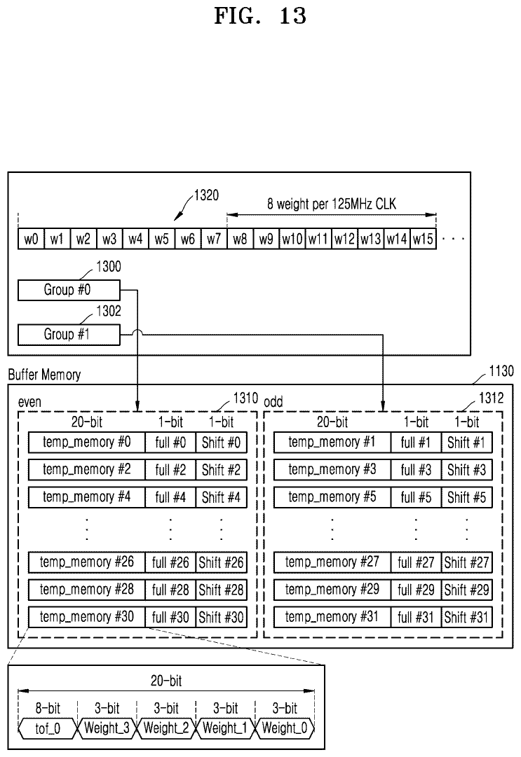

An operation process of the histogram generation unit 424 in a QR mode 1150 will be described with reference to FIGS. 11 and 13 together.

Four photonic event detection results recognized at intervals of 2 ns during a measurement period of 8 ns for odd pixels may be output as four upper weights through the weight recognition unit 710, and four photonic event detection results recognized at intervals of 2 ns during a measurement period of 8 ns for even pixels may be output as four lower weights through the weight recognition unit 710. Thus, the histogram generation unit 424 may receive a total of eight weights 1110 and 1320.

The histogram generation unit 424 may separately store a first group 1300 and a second group 1302 as four results (i.e., four upper weights) of the odd pixels and four results (i.e., four lower weights) of the even pixels, and recognize whether a sum of weights of each of the groups 1300 and 1302 exceeds a predefined threshold value as indicated by 1120. When a sum of weights in each group is less than or equal to the threshold value, the histogram generation unit 424 may discard the weights of the group and do not reflect them in the histogram. In an embodiment, the histogram generation unit 424 may recognize, in parallel, whether the sum of weights in each group exceeds the threshold value.

When the sum of weights in the group exceeds the threshold value, the histogram generation unit 424 may store the weights of the group in the buffer memory 1130. In a QR mode 1150, photonic event detection of the odd pixels and the even pixels is performed in parallel, such that the histogram generation unit 424 may divide the buffer memory 1130 into two groups (e.g., an even memory 1310 and an odd memory 1312) for two QR pixels. The first group 1300 may use the even memory 1310, and the second group 1302 may use the odd memory 1312. In other words, when the signal detection unit 422 operates at a resolution of 2 ns in the QR mode, the even pixels may be assigned to the even memory 1310 and the odd pixels may be assigned to the odd memory 1312.

The histogram generation unit 424 may accumulatively store detection results of the odd pixels and the even pixels stored in the buffer memory 1130 separately in an odd pixel histogram and an even pixel histogram of the histogram memory. Histograms for two pixels may be respectively stored in the memory 430.

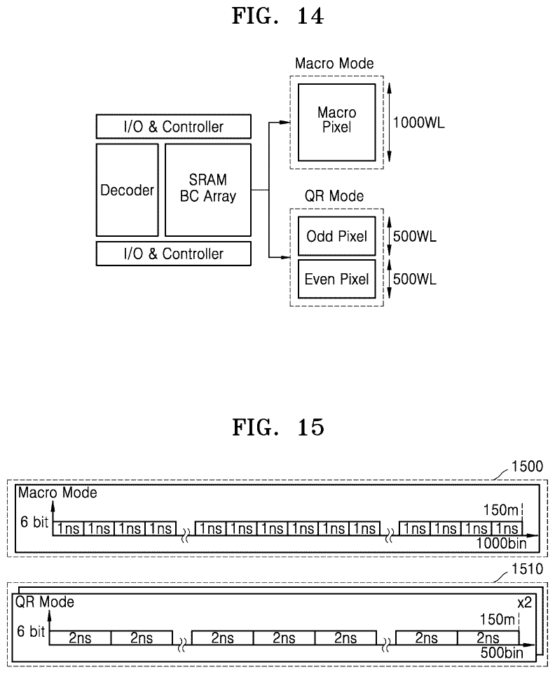

FIG. 14 shows an example of a histogram memory according to an embodiment.

Referring to FIG. 14, the histogram memory may store one histogram for a macro-pixel in the macro mode. In the QR mode, the histogram memory may be divided into two regions in which histograms for odd pixels and even pixels are respectively stored. For example, 1000 word lines (WL) all may be assigned to one macro pixel in the macro mode, but 500 upper WL may be assigned to odd pixels and 500 lower WL may be assigned to even pixels, in the QR mode.

FIG. 15 shows an example of histograms in a macro mode and in a QR mode, according to an embodiment.

Referring to FIG. 15, in the macro mode, the signal processing apparatus 420 may generate a histogram including 1000 bins in the unit of 1 ns. As 1 ns corresponds to 15 cm, the light-receiving sensor 400 may detect an object up to a range of 150 m (=15 cm*1000). To maintain a maximum detection range of 150 m, the signal processing apparatus 420 may two histograms including 500 bins in the unit of 2 ns in the QR mode. In the QR mode, two histograms may respectively correspond to odd pixels and even pixels. That is, when the macro mode is changed to the QR mode, the signal processing apparatus 420 may reconfigure a histogram including 1000 bins in the unit of 1 ns into a histogram including 500 bins in the unit of 2 ns. Sizes of the histogram memories required for the macro mode and the QR mode may be equal to each other. In the QR mode, a time resolution increases from 1 ns to 2 ns, but the time resolution may be improved through the filter unit 440. This will be described with reference to FIGS. 16 and 17.

FIGS. 16 and 17 show an example of a method of improving a time resolution of a histogram, according to an embodiment.

Referring to FIG. 16, the signal processing apparatus 420 may generate a histogram 1600 of each pixel and improve a time resolution through the filter unit 440. The signal processing apparatus 420 may multiply a laser pulse model 1610 simulating a shape of a laser pulse used for ToF measurement by the histogram 1600 while moving the laser pulse model 1610 at predefined intervals. A moving interval of the laser pulse model 1610 may be less than a time interval of a bin. The filter unit 440 may generate ToF data having a time resolution corresponding to the moving interval of the laser pulse model 1610. That is, the signal processing apparatus 420 may improve a time resolution of a histogram through convolution of the laser pulse model 1610 and the histogram 1600.

A method of improving a time resolution will be described in more detail with reference to FIG. 17. A laser pulse model 1700 may divide a width of a laser into a plurality of time intervals (hereinafter, ‘sub-time zones’) and include a magnitude of a laser for each sub-time zone. For example, when a width of a laser pulse is 7 ns, 7 ns may be divided into 112 sub-time zones and a laser pulse model 1700 including a magnitude of the laser pulse in each sub-time zone may be defined. That is, the laser pulse model 1700 may be modeled at intervals of 62.5 ps (corresponding to 0.94 cm). In addition, the laser pulse model 1700 may be defined in various manners and is not limited to the current embodiment.

The filter unit 440 may overlap the laser pulse model 1700 with the histogram 1600 and multiply a frequency stored in each bin 1710 by a value at a corresponding position of the laser pulse model 1700. As a time interval of each bin 1710 of the histogram 1600 is 1 ns, the number of sub-time zones of the laser pulse model 1700 corresponding to each bin may be 16 to the maximum (62.5 ps*16=1 ns).

First, when the laser pulse model 1700 completely coincides with b0-b6 of the bin 1710, the filter unit 440 may divide the laser pulse model 1700 into a total of seven groups corresponding to each bin and obtain a weight 1720 of each group. For example, magnitudes of a laser pulse for sub-time zones 0˜15 belonging to a first group of the laser pulse model 1710 may be summed to obtain a first weight w0, and magnitudes of a laser pulse for sub-time zones 16˜30 belonging to a second group may be summed to obtain a second weight w1. In this way, weights w0, w1, . . . , w6 of a total of seven groups of the laser pulse model 1700 may be obtained. Since each of the seven groups of the laser pulse model 1700 corresponds to the bins b0 to b6 of the histogram 1710, the filter unit 440 may multiply each frequency of the bins b0 to b6 of the histogram 1710 by each weight of the seven groups of the laser pulse model 1700. That is, the filter unit 440 may calculate a similarity between a laser pulse model and a histogram.

Next, the filter unit 440 may move the laser pulse model 1700 by a sub-time zone (i.e., 62.5 ps) of the laser pulse model 1700 and then multiply the laser pulse model 1700 by the histogram 1600 again. As the laser pulse model 1700 moves by 62.5 ps, a position of a sub-time zone of the laser pulse model 1700 overlapping each bin 1710 may be changed. That is, as the laser pulse model 1700 moves by 62.5 ps, the laser pulse model 1700 may overlap a total of eight bins b0 to b7. The first group of the laser pulse model 1700 overlapping the bin b0 may include sub-time zones 0˜14, and the second group of the laser pulse model 1700 overlapping the bin b1 may include sub-time zones 15˜29. An eighth group of the laser pulse model 1700 overlapping the bin b7 may include sub-time zone 111. Instead that the sub-time zones of the laser pulse model overlapping the bin b0 are reduced by one, one sub-time zone of the laser pulse model corresponding to the bin b7 is newly added.

The filter unit 440 may obtain weights of the first to eighth groups of the laser pulse model 1700 and then respectively multiply the bins b0 to b7 by the weights of the first to eight groups and store them, thereby calculating a similarity with the laser pulse model 1700. By repeating this process 16 times (i.e., 6.25 ps*16=1 ns), the laser pulse model 1700 may be shifted to overlap with the bins b1 to b8 of the histogram 1600.

For the bins b1 to b8, the laser pulse model 1700 may be multiplied by the histogram 1600. A peak value may be obtained from a value obtained by performing a process of multiplying the laser pulse model by the histogram up to the bins 1710 b0 to b15, thereby finally determining a ToF. Through time resolution improvement of the filter unit 440, a distance to an object may be more precisely measured.

In an embodiment, the filter unit 440 may improve a time resolution by multiplying the entire zone of the histogram 1600 by the laser pulse model 1700. However, in this case, a large number of computation processes need to be performed.

In another embodiment, the filter unit 440 may set a region of interest including a predetermined number of (e.g., a total of 16) bins 1710 at both sides around a bin having the highest frequency in the histogram 1600 and then multiply the region of interest by the laser pulse model 1700 to improve the time resolution.

For example, when a width of the laser pulse is about 8 ns, the number of detections of the laser pulse in the histogram may be accumulated in about eight bins. Therefore, the filter unit 440 may select, as the region of interest, eight bins around the bin having the highest frequency in the histogram 1600. In another example, for a case where eight bins including noise are selected and a part of the laser pulse (e.g., a half of the width) is incident over the selected eight bins, four bins may be further selected at both sides of the selected eight bins as the region of interest. In addition, the number of bins set as a region of interest by the filter unit 440 may be determined variously considering a width of a laser pulse and a redundancy.

FIG. 18 shows an example of a signal processing method for implementing multi-resolutions, according to an embodiment.

Referring to FIG. 18, the signal processing apparatus 420 may perform photonic event detection processes in parallel for at least two light-receiving elements of a pixel array, in operation S1800. For example, in the macro mode, the signal processing apparatus 420 may detect, in parallel, whether photonic events occur for a plurality of light-receiving elements constituting a macro-pixel. In the QR mode, the signal processing apparatus 420 may detect, in parallel, whether photonic events occur for light-receiving elements of odd pixels and even pixels of the macro-pixel corresponding to the QR pixel.

The signal processing apparatus 420 may accumulate detection results about the photonic events recognized at predefined time intervals in a plurality of bins and generate a histogram, in operation S1810. For example, in the macro mode, the signal processing apparatus 420 may generate the histogram in the unit of a macro-pixel. In the QR mode, the signal processing apparatus 420 may generate a histogram for each odd pixel and each even pixel.

Upon completion of generation of the histogram, the signal processing apparatus 420 may multiply the laser pulse model by the histogram and perform a filtering process for improving a time resolution, in operation S1820. In another embodiment, the filtering process performed in operation S1820 may be omitted.

The disclosure may also be implemented as a computer-readable program code on a computer-readable recording medium. The computer-readable recording medium may include all types of recording devices in which data that is readable by a computer system is stored. Examples of the computer-readable recording medium may include read-only memory (ROM), random access memory (RAM), compact-disc ROM (CD-ROM), a magnetic tape, a floppy disk, an optical data storage device, etc. The computer-readable recording medium may be distributed over computer systems connected through a network to store and execute a computer-readable code in a distributed manner.

So far, embodiments have been described for the disclosure. It would be understood by those of ordinary skill in the art that the disclosure may be implemented in a modified form within a scope without departing from the essential characteristics of the disclosure. Therefore, the disclosed embodiments should be considered in a descriptive sense rather than a restrictive sense. The scope of the present specification is not described above, but in the claims, and all the differences in a range equivalent thereto should be interpreted as being included in the disclosure.

According to an embodiment, a light-receiving sensor with multi-resolutions may be implemented while maintaining a TDC area. In another embodiment, a time resolution of a histogram may be improved by shifting the laser pulse model and multiplying the laser pulse model by the histogram. A reconfigurable histogram hTDC and a memory may be implemented in a narrow pixel pitch (e.g., 30.24 μm).

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A signal processing apparatus comprising:
a signal detection unit configured to perform photonic event detection processes in parallel for at least two light-receiving elements of a pixel array; and
a histogram generation unit configured to accumulate detection results about photonic events recognized at predefined time intervals by the signal detection unit in a plurality of bins and generate a histogram.

2. The signal processing apparatus of claim 1, wherein the signal detection unit is further configured to perform the photonic event detection processes in parallel for a plurality of light-receiving elements constituting each pixel in the unit a pixel.

3. The signal processing apparatus of claim 2, wherein the pixel comprises light-receiving elements arranged in an n*m array (n and m are natural numbers of at least 2).

4. The signal processing apparatus of claim 1, wherein the signal detection unit is further configured to perform photonic event detection processes in parallel for a plurality of pixels, and
each of the plurality of pixels comprises at least one light-receiving element.

5. The signal processing apparatus of claim 1, wherein the signal detection unit comprises a plurality of edge detectors one-to-one mapped to a plurality of light-receiving elements and configured to detect a photonic event of each light-receiving element in a predefined time interval.

6. The signal processing apparatus of claim 5, wherein each of the plurality of edge detectors comprises a plurality of flipflops configured to operate in different phases for a common clock frequency, and
a phase difference between the plurality of flipflops corresponds to the time interval.

7. The signal processing apparatus of claim 5, further comprising a weight recognition unit configured to accumulate a number of photonic event detections of each edge detector at each time interval and to recognize a weight for each time interval.

8. The signal processing apparatus of claim 7, wherein the weight recognition unit comprises a plurality of edge counters configured to output in parallel a number of detections of each edge detector for each time interval.

9. The signal processing apparatus of claim 7, further comprising a synchronizer configured to synchronize the weight for each time interval and output the synchronized weight.

10. The signal processing apparatus of claim 1, wherein the histogram generation unit is further configured to compare a cumulative value of a number of photonic event detections for a predetermined number of consecutive time intervals with a predefined threshold value to determine whether to accumulate the number of photonic event detections for the predetermined number of consecutive time intervals in the histogram.

11. The signal processing apparatus of claim 1, wherein the signal detection unit is further configured to detect photonic events in parallel for a plurality of pixels comprising at least one light-receiving element, and
the histogram generation unit is further configured to perform in parallel a process of determining whether to accumulate a histogram for the plurality of pixels.

12. The signal processing apparatus of claim 1, wherein the signal detection unit is further configured to determine a size of a time interval for detecting a photonic event according to a number of light-receiving elements constituting a pixel.

13. The signal processing apparatus of claim 1, further comprising a filter unit configured to repeat a process of multiplying a laser pulse model by the histogram while shifting the laser pulse model at intervals of a sub-time zone less than a time interval of a bin and to improve a time resolution of the histogram to a size of the sub-time zone.

14. The signal processing apparatus of claim 13, wherein the filter unit is further configured to extract a region of interest comprising a predetermined number of bins around a bin having highest frequency in the histogram and perform a process of the multiplication while shifting the laser pulse model over the region of interest.

15. A signal processing method performed by a signal processing apparatus connected to a pixel array, the signal processing method comprising:
performing photonic event detection processes in parallel for at least two light- receiving elements of a pixel array; and
accumulating detection results about photonic events recognized at predefined time intervals in a plurality of bins and generating a histogram.

16. The signal processing method of claim 15, wherein the performing of the photonic event detection processes in parallel comprises detecting, for each light-receiving element, a photonic event for the light-receiving element by using a plurality of flipflops operating in different phases for a common clock frequency.

17. The signal processing method of claim 15, wherein the performing of the photonic event detection processes in parallel comprises accumulating a number of photonic event detections of each edge detector at each time interval and recognizing a weight for each time interval, and
the generating of the histogram comprises accumulating the weight for each time interval in a bin and generating a histogram.

18. The signal processing method of claim 15, wherein the generating of the histogram comprises accumulating a number of photonic event detections for a predetermined number of consecutive time intervals in the histogram when a cumulative value of the number of photonic event detections for the predetermined number of consecutive time intervals is greater than a predefined threshold value.

19. The signal processing method of claim 15, wherein the generating of the histogram comprises:
dividing a histogram memory into a plurality of regions according to a number of pixels to which the at least two light-receiving elements belong; and
storing a histogram corresponding to each pixel in the plurality of regions.

20. The signal processing method of claim 15, further comprising repeating a process of multiplying a laser pulse model by the histogram while shifting the laser pulse model at intervals of a sub-time zone less than a time interval of a bin and improving a time resolution of the histogram to a size of the sub-time zone.
